(19) United States
(12) Patent Application Publication
(10) Pub. No.: US 2011/0002055 A1
(43) Pub. Date: Jan. 6, 2011

(54) LENS STRUCTURE FOR MINIATURE LENS DRIVING MECHANISM AND MANUFACTURING METHOD THEREOF

(76) Inventor: Yi-Liang CHAN, Yangmei Taoyuan (TW)

Correspondence Address: Muncy, Geissler, Olds & Lowe, PLLC, 4000 Legato Road, Suite 310, FAIRFAX, VA, 22033, US

(21) Appl. No.: 12/497,295

(22) Filed: Jul. 2, 2009

(51) Int. Cl. G02B 7/04; B32B 37/00

(52) U.S. Cl. 359/823; 156/293

(57) ABSTRACT

A lens structure in lens driving mechanism includes a lens unit having a lens barrel consists of at least one lens and a lens brace and a barrel holder. The lens and the lens brace are connected to one another by applying a bonding agent on an outer periphery of the lens and an inner wall surface of the lens brace without using any screwing structure. The barrel holder is a hollow cylindrical member for receiving the lens barrel therein, and the lens barrel and the barrel holder are connected to one another by applying a bonding agent on an outer periphery of the lens brace and an inner wall surface of the barrel holder without using any screwing structure. Therefore, space that is otherwise occupied by the screwing structure is saved to enable further miniaturized lens structure, and frictional contact wear in the screwing structure is avoided.

### FIELD OF THE INVENTION

The present invention relates to a lens structure for miniature lens driving mechanism and a manufacturing method thereof; and more particularly to a lens unit without screwing structure and a manufacturing method thereof. The lens unit without screwing structure can effectively reduce the volume of the lens structure and allows fine adjustment of inclination and focusing position of the lens unit during the manufacturing process thereof.

### BACKGROUND OF THE INVENTION

A miniature lens driving mechanism is mainly used to drive a focusing lens to move along an optical axis direction, so that light reflected from an image is focused on an image sensor. Currently, the miniature lens driving mechanism has already been widely employed on electronic devices with a camera function, such as a cellular phone. The miniature lens driving mechanism can have many different driving modes. For example, Japanese Patent Application No. 2008-129597, which claims priority from China Invention Patent Application No. 200610157001.2, discloses a structure using a stepping motor to drive lens focusing, in which the lens is driven though a screwing structure provided between a stator and a rotator to move upward and downward and focus.

The lens driving structure disclosed in Japanese Patent Application No. 2008-129597 enables different functions, including fine adjustment and fixing of lens, as well as auto-focusing. In addition, a screwing structure is also employed between two protective layers separately formed on the lens and the rotor. In the case of using a screwing structure to lock the lens in place, the screwing structure itself will occupy some space in the lens driving mechanism. Moreover, the screwing structure does not allow horizontal fine adjustment of the lens when the problem of unfocused image occurs due to an inclination of the lens relative to the image sensor. Therefore, the lens forms a defective product.

Further, with the screwing structure, whenever the lens is finely adjusted, fixed, and auto-focused, a small amount of frictional contact wear will occur at the screwing structure. This condition not only consumes more power, but also produces minor noise, resulting in reduced lens quality.

It is therefore tried by the inventor to overcome the problems with the conventional miniature lens driving mechanism by developing a lens structure that uses a bonding agent to bond the lenses to a lens brace or a barrel holder instead of using the screwing structure, so that the space that is otherwise occupied by the screwing structure is saved to enable further miniaturization of the lens structure, and the problems of frictional contact wear and minor noise caused by the screwing structure are avoided. Moreover, during the process of bonding the lens to the lens brace or the barrel holder, inclination adjustment of the lens relative to the image sensor can be finely performed without being restricted by a screwing structure. Therefore, the yield of defective products is reduced, and quality of the miniature lens driving mechanism is upgraded.

### SUMMARY OF THE INVENTION

A primary object of the present invention is to provide a lens structure in a lens driving mechanism and a method of manufacturing the lens structure. The lens structure is a lens unit without screwing structure and linearly displaceable along an optical axis direction to focus image light on an image sensor, so that the lens unit can be further miniaturized and various problems in conventional lens structure due to the use of a screwing structure can be avoided.

To achieve the above and other objects, the lens unit according to the present invention includes a lens barrel consisting of at least one lens and a lens brace, and a barrel holder. The lens and the lens brace are connected to one another by applying a bonding agent on an outer periphery of the lens and an inner wall surface of the lens brace without using any screwing structure. The barrel holder is a hollow cylindrical member for receiving the lens barrel therein, and the lens barrel and the barrel holder are connected to one another by applying a bonding agent on an outer periphery of the lens barrel and the inner wall surface of the barrel holder without using any screwing structure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an embodiment of a lens driving mechanism in which the lens structure of the present invention is used;

FIG. 2A is a sectioned side view of a lens unit without screwing structure according to a first embodiment of the present invention;

FIG. 2B is a top view of the lens unit of FIG. 2A;

FIG. 3 is a flowchart showing the steps included in a method of manufacturing the lens unit without screwing structure according to the first embodiment of the present invention;

FIG. 4A is a sectioned side view of a lens unit without screwing structure according to a second embodiment of the present invention;

FIG. 4B is a top view of the lens unit of FIG. 4A; and

FIG. 5 is a flowchart showing the steps included in a method of manufacturing the lens unit without screwing structure according to the second embodiment of the present invention.

### DETAILED DESCRIPTION OF THE PREFERRED EMBODIMENTS

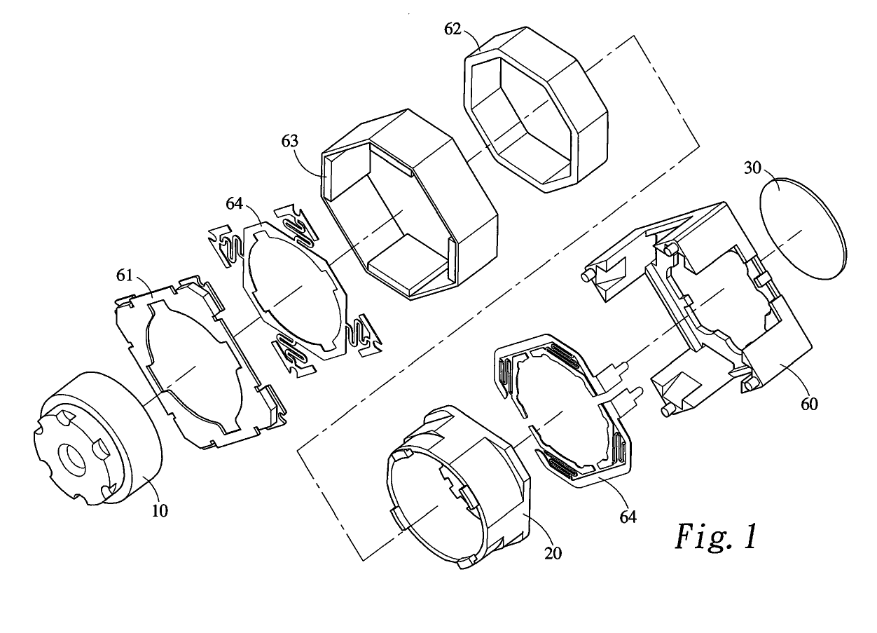

Please refer to FIG. 1 that is an exploded perspective view of an embodiment of a lens driving mechanism in which the lens structure of the present invention is used. As shown, the lens driving mechanism includes a barrel holder 20 for holding a lens barrel 10 therein. The barrel holder 20 is received in a hollow frame 60 having a front cover 61 connected thereto. A winding element 62 is fitted around the barrel holder 20, and four permanent magnets 63 are correspondingly arranged on an outer side of the winding element 62. Two elastic members 64 are separately connected to a front and a rear side of the barrel holder 20, so that the barrel holder 20 is suspended and centered in the frame 60 via the elastic members 64. Further, an image sensor 30 is arranged behind the frame 60.

Electric current can be supplied to the winding element 62 via the rear elastic member 64, so that an electromagnetic field is produced by the winding element 62, and a repelling force is generated between the winding element 62 and the four permanent magnets 63. However, being restricted by the two elastic members 64, the barrel holder 20 is allowed to displace forward and rearward in a linear motion within the frame 60. Therefore, light enters the lens barrel 10 held in the barrel holder 20 can be focused on the image sensor 30.

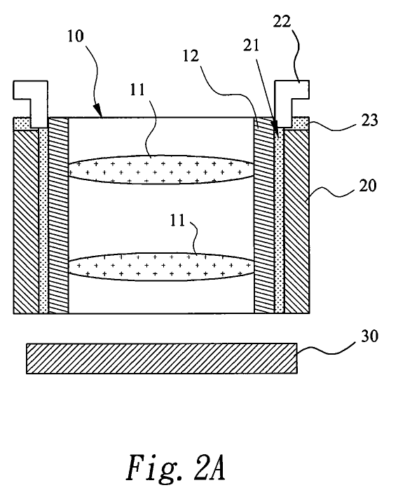

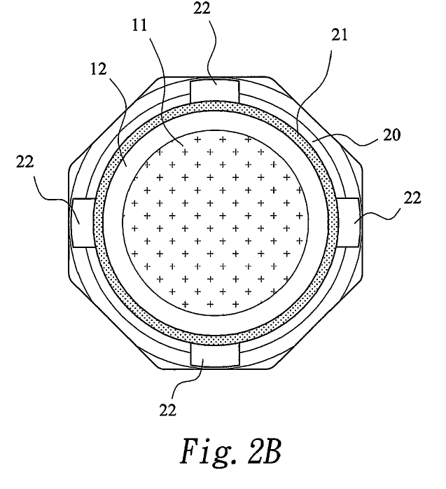

Please refer to FIGS. 2A and 2B that are sectioned side view and top view, respectively, of a lens unit without screwing structure according to a first embodiment of the present invention. As can be understood from the above description, the lens driving mechanism drives a lens unit 1 to linearly move along an optical axis direction, so that image light entering the lens unit 1 is automatically focused on the image sensor 30. A primary object of the present invention is to design a lens unit 1 without screwing structure and a method of manufacturing the lens unit 1. According to the first embodiment of the present invention, the lens unit 1 includes a lens barrel 10 and a barrel holder 20.

The lens barrel 10 consists of at least one lens 11 and a lens brace 12. In the first embodiment illustrated in FIG. 2A, the lens barrel 10 consists of two lenses 11 and a cylindrical lens brace 12. There is not any screwing structure provided between the lenses 11 and the lens brace 12 for fastening them to one another. Instead, a bonding agent is applied on an outer periphery of each of the lenses 11 and an inner wall surface of the lens brace 12 to thereby bond the lenses 11 and the lens brace 12 to one another.

The barrel holder 20 is in the form of a hollow cylinder for receiving the lens barrel 10 therein. A clearance 21 is formed between an outer periphery of the lens brace 12 and an inner wall surface of the barrel holder 20, as shown in FIG. 2B. The clearance 21 is fully filled with a bonding agent, so that the inner wall surface of the barrel holder 20 and the outer periphery of the lens barrel 10 are fixedly bonded together. During the process of applying the bonding agent to bond the lens barrel 10 and the barrel holder 20 to each other, inclination adjustment and focusing adjustment of the lens barrel 10 relative to the image sensor 30 can be finely performed step by step.

The barrel holder 20 is provided at a light-input side thereof with at least one connecting member 22 for connecting the barrel holder 20 to the front elastic member 64 in the lens driving mechanism, so that the barrel holder 20 can keep the linear displacement along the optical axis direction. A groove 23 is formed between the connecting member 22 and the barrel holder 20 for receiving and storing surplus bonding agent therein.

The barrel holder 20 can be externally surrounded by the winding element 62 or by a magnetic element. Preferably, the barrel holder 20 has a circular outer peripheral wall. However, the barrel holder 20 can otherwise have a square, an octagonal, or other polygonal-shaped outer peripheral wall.

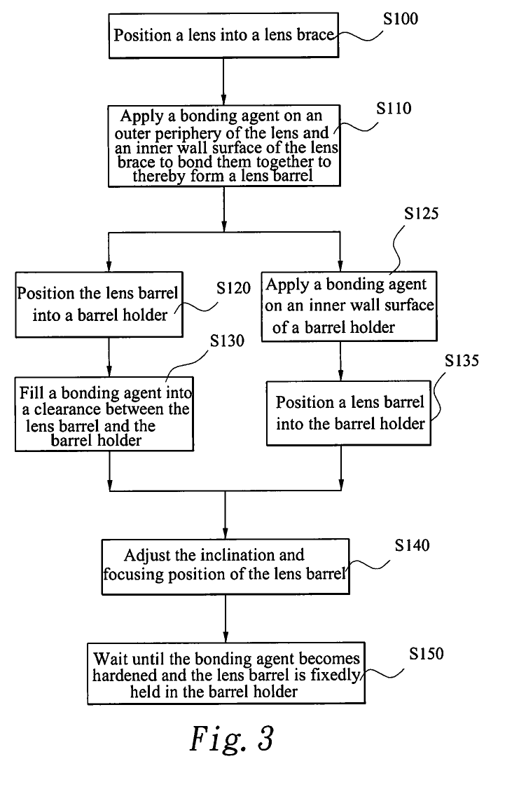

FIG. 3 is a flowchart showing the steps included in a method of manufacturing the lens unit without screwing structure according to the first embodiment of the present invention. In a first step S100, at least one lens 11 is positioned in a lens brace 12; in a second step S110, a bonding agent is applied to bond an outer periphery of the at least one lens 11 to an inner wall surface of the lens brace 12, so as to form a lens barrel 10; in a third step S120, the lens barrel 10 is positioned in a barrel holder 20; in a fourth step S130, a bonding agent is filled in a clearance 21 between the lens brace 12 and the barrel holder 20; in a fifth step S140, step by step, the lens barrel 10 is finely adjusted in its inclination and focusing position; and in a final step S150, when the bonding agent has become hardened, the lens barrel 10 is fixedly held in the barrel holder 20.

Alternatively, after the Step 110 of forming the lens barrel 10, first apply a bonding agent on an inner wall surface of a barrel holder 20 (Step 125), and then position the lens barrel 10 into the barrel holder 20 (Step 135). Thereafter, finely adjust the inclination and focusing position of the lens barrel 10 step by step (Step 140), and then, when the bonding agent has become hardened, the lens barrel 10 is fixedly held in the barrel holder 20 (Step 150).

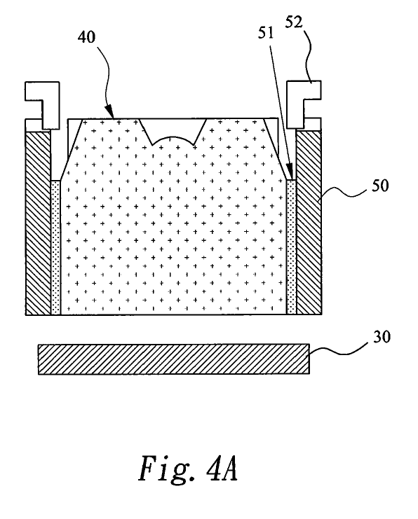

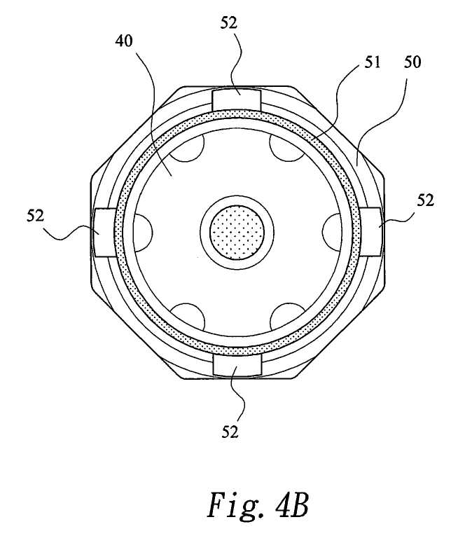

Please refer to FIGS. 4A and 4B that are sectioned side view and top view, respectively, of a lens unit without screwing structure according to a second embodiment of the present invention. In the second embodiment, the lens unit 2 includes a lens barrel 40 and a barrel holder 50. The lens barrel 40 consists of only a simple lens object, and the lens brace in the first embodiment is omitted from the second embodiment, so as to further miniaturize the lens structure. The barrel holder 50 is in the form of a hollow cylinder for receiving the lens barrel 40 therein. There is not any screwing structure provided between the lens barrel 40 and the barrel holder 50. A clearance 51 is formed between an outer periphery of the lens barrel 40 and an inner wall surface of the barrel holder 50, as shown in FIG. 4B. The clearance 51 is fully filled with a bonding agent, so that the lens barrel 40 is bonded to and fixedly held in the barrel holder 50 via the bonding agent.

As in the first embodiment, during the process of filling the bonding agent to bond the lens barrel 40 and the barrel holder 50 to each other, inclination adjustment and focusing adjustment of the lens barrel 40 relative to the image sensor 30 can be finely performed step by step. The barrel holder 50 can be further provided at a light-input side thereof with at least one connecting member 52 for connecting the barrel holder 50 to the front elastic member 64 in the lens driving mechanism, so that the barrel holder 50 can keep the linear displacement along the optical axis direction.

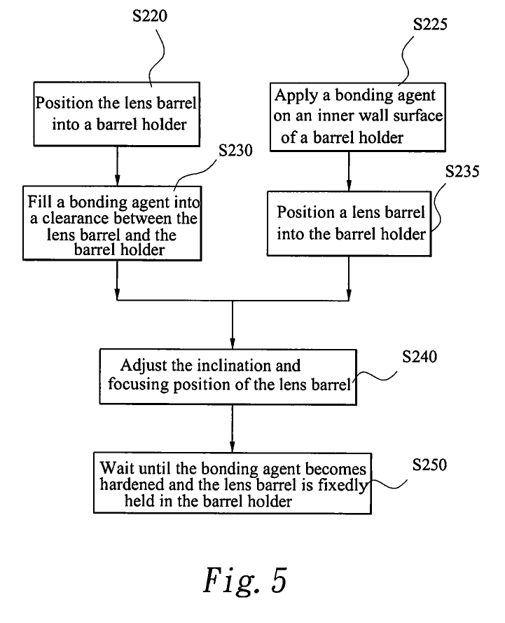

FIG. 5 is a flowchart showing the steps included in a method of manufacturing the lens unit without screwing structure according to the second embodiment of the present invention. In a first step S220, a lens barrel 40 is positioned in a barrel holder 50; in a second step S230, a bonding agent is filled into a clearance 51 formed between the lens barrel 40 and the barrel holder 50; in a third step S240, step by step, the lens barrel 40 is finely adjusted in its inclination and focusing position; and in a final step S250, when the bonding agent has become hardened, the lens barrel 40 is fixedly held in the barrel holder 50.

Alternatively, in the method of manufacturing the lens unit without screwing structure according to the second embodiment of the present invention, first apply a bonding agent on an inner wall surface of a barrel holder 50 (Step 225), and then position a lens barrel 40 into the barrel holder 50 (Step 235). Thereafter, finely adjust the inclination and focusing position of the lens barrel 40 step by step (Step 240), and then, when the bonding agent has become hardened, the lens barrel 40 is fixedly held in the barrel holder 50 (Step 250).

The lens unit without screwing structure and the manufacturing method thereof according to the present invention provide the following features and advantages:
1. Since there is not any screwing structure provided between the lens barrel and the barrel holder, volume that is otherwise occupied by the screwing structure can be saved to enable further miniaturization of the lens driving mechanism.
2. Since the screwing structure is omitted, the problem of deformed elastic members due to fastening by screwing as found in the prior art can be solved, and noise generated by the lens unit when being compressed during screwing can be avoided.
3. The lens barrel can be adjusted in its inclination and focusing position during the manufacturing process of the lens unit without being restricted by a screwing structure.
4. The lens barrel can be formed using lenses and a lens brace to save the cost for buying a ready-made lens object to form the lens barrel.

What is claimed is:

1. A lens structure in a lens driving mechanism, comprising at least one lens unit linearly displaceable along an optical axis direction to thereby focus image light on an image sensor; the lens unit including at least one lens barrel and a barrel holder, the barrel holder being in the form of a hollow cylinder for receiving the lens barrel therein, and the lens barrel and the barrel holder being connected to one another via a bonding agent applied on an outer periphery of the lens barrel and an inner wall surface of the barrel holder without using any screwing structure between the lens barrel and the barrel holder.

2. The lens structure in a lens driving mechanism as claimed in claim 1, wherein the lens barrel includes at least one lens and a lens brace.

3. The lens structure in a lens driving mechanism as claimed in claim 1, wherein the lens barrel includes only a simple lens object.

4. The lens structure in a lens driving mechanism as claimed in claim 1, wherein the lens barrel is finely adjustable in inclination and focusing position relative the image sensor when the lens barrel is bonded to the barrel holder via the bonding agent.

5. The lens structure in a lens driving mechanism as claimed in claim 1, wherein a clearance is formed between the outer periphery of the lens barrel and the inner wall surface of the barrel holder, and the bonding agent is filled into the clearance to bond the lens barrel to the barrel holder.

6. The lens structure in a lens driving mechanism as claimed in claim 2, wherein a clearance is formed between an outer periphery of the lens and an inner wall surface of the lens brace, and the clearance being filled with a bonding agent to bond the outer periphery of the lens to the inner wall surface of the lens brace.

7. The lens structure in a lens driving mechanism as claimed in claim 1, wherein the barrel holder further includes at least one connecting member for connecting the barrel holder to at least one elastic member in the lens driving mechanism.

8. A method of manufacturing a lens unit in a lens driving mechanism, the lens unit being linearly displaceable along an optical axis direction to thereby focus image light on an image sensor; comprising the following steps:
preparing a lens barrel; preparing a barrel holder in the form of a hollow cylinder for receiving the lens barrel therein; and
using a bonding agent to bonding the lens barrel to the barrel holder.

9. The lens unit manufacturing method as claimed 8, wherein, during the step of bonding the lens barrel to the barrel holder, inclination adjustment and focusing adjustment of the lens barrel relative to the image sensor are performed step by step.

10. The lens unit manufacturing method as claimed 8, wherein, in the step of preparing the lens barrel, further includes the following steps:
preparing at least one lens;
preparing a lens brace in the form of a hollow cylinder; and
positioning the lens into the lens brace, and applying a bonding agent on an outer periphery of the lens and an inner wall surface of the lens brace to bond the lens and the lens brace to one another.

11. The lens unit manufacturing method as claimed 8, wherein, in the step of bonding the lens barrel to the barrel holder, further includes the following steps:
positioning the lens barrel into the barrel holder;
filling the bonding agent into a clearance formed between the lens barrel and the barrel holder;
adjusting the lens barrel in its inclination and focusing position; and
waiting until the bonding agent becomes hardened to fixedly hold the lens barrel in the barrel holder.

12. The lens unit manufacturing method as claimed 8, wherein, in the step of bonding the lens barrel to the barrel holder, further includes the following steps:
applying the bonding agent on an inner wall surface of the barrel holder;
positioning the lens barrel into the barrel holder;
adjusting the lens barrel in its inclination and focusing position; and
waiting until the bonding agent becomes hardened to fixedly hold the lens barrel in the barrel holder.
